(19) United States
(12) Patent Application Publication
(10) Pub. No.: US 2018/0063246 A1
(43) Pub. Date: Mar. 1, 2018

(54) METHOD AND APPARATUS FOR EFFICIENT DATA TRANSFER PROTOCOL IN A LIMITED-BANDWIDTH VEHICLE ENVIRONMENT

(71) Applicant: FORD GLOBAL TECHNOLOGIES, LLC, Dearborn, MI (US)

(72) Inventors: John Naum VANGELOV, South Lyon, MI (US); Jason Michael MILLER, Woodhaven, MI (US); Sangeetha SANGAMESWARAN, Canton, MI (US); John William SCHMOTZER, Canton, MI (US)

(21) Appl. No.: 15/253,177

(22) Filed: Aug. 31, 2016

(51) Int. Cl. H04L 29/08; B60R 16/023; H04L 12/40

(52) U.S. Cl. CPC H04L 67/12; B60R 16/023; H04L 41/12; H04L 12/40013; H04L 67/327

(57) ABSTRACT

A system includes a processor configured to receive a 29-bit request transmitted over a vehicle controller area network (CAN) bus. The processor is also configured to identify a vehicle electronic control unit (ECU) as a target recipient based on a target identifier included with the request. The processor is further configured to identify a source which sent the request based on a source identifier included with the request. Also, the processor is configured to verify the identified source as permitted to send the request to the ECU and, responsive to the verification, route the request to an ECU application, executing on the ECU, identified by an application identifier included with the request.

### TECHNICAL FIELD

The illustrative embodiments generally relate to a method and apparatus for efficient data transfer protocol in a limited-bandwidth vehicle environment.

### BACKGROUND

Vehicle telematics systems have added a powerful tool to the vehicular computing arsenal. Using a telematics control unit (TCU) and a wirelessly connected device (such as a cell phone) or on-board modem, a vehicle can access a variety of data that is stored remotely from the vehicle. At the same time, the vehicle can run off-board diagnostics, file updates, error checking and general system queries. Many off-board access requests require or request some data typically available over a vehicle controller area network (CAN). The CAN bus connects a variety of vehicle modules, allowing communication among modules and further providing data resources (such as data from modules) to remote system queries.

CAN is the main communication method on present day automobiles. As a result, automotive original equipment manufacturers (OEM)s have to take into account bandwidth limitations of the physical layer, as well as network topology that has multiple baud rates and modules that may exist on different subnets across different product lines. The result of different product lines having similar modules or electronic control units (ECUs) on different subnets is that a message sender that would route a message to a first subnet on a first vehicle model to reach ECU₁ may have to route the same message to a different subnet on a different vehicle model to reach ECU₁. If gateways or senders route messages based on a predefined message type, a sender may have to reconfigure the message type for each product line to ensure it reaches the proper destination (and/or know which subnet contains the desired ECU in advance). Otherwise, the sender would route a predefined message of type X to the appropriate subnet (based on it being a type X message) on the first product line and the same, but wrong, subnet on the second product line (because the intended ECU lies on a different subnet in the second product line).

Also, OEM additions to the variety of intended uses of the CAN bus in conjunction with the TCU, such as firmware updates and new telematics features, may exhaust the usable network 11-bit IDs. Improved transfer protocols address and work with existing limitations to allow for improved functionality and communication across a variety of subnets.

### SUMMARY

In a first illustrative embodiment, a system includes a processor configured to receive a 29-bit request transmitted over a vehicle controller area network (CAN) bus. The processor is also configured to identify a vehicle electronic control unit (ECU) as a target recipient based on a target identifier included with the request. The processor is further configured to identify a source which sent the request based on a source identifier included with the request. Also, the processor is configured to verify the identified source as permitted to send the request to the ECU and, responsive to the verification, route the request to an ECU application, executing on the ECU, identified by an application identifier included with the request.

In a second illustrative embodiment, a computer-implemented method includes routing a message to an identified target ECU via a synchronous data link control module, responsive to receipt of a 29-bit message, including a 10-bit target identifier identifying a target electronic control unit (ECU) and 10-bit source identifier identifying a message source, following verification by the ECU of both the identified source as being permitted to exchange messages with the ECU and 29-bit request handling capability.

In a third illustrative embodiment, a non-transitory computer-readable storage medium stores instructions that, when executed by a processor, cause the processor to perform a method including identifying a vehicle electronic control unit (ECU) as a target recipient based on a target identifier included with a 29-bit request from a vehicle controller area network (CAN) bus. The method also includes verifying a source identified in the 29-bit request as permitted to send the request to the ECU and routing the request to an ECU application, executing on the ECU, responsive to the verification, the application identified by an application identifier included with the request.

### BRIEF DESCRIPTION OF THE DRAWINGS

FIG. 1 shows an illustrative vehicle computing system;

FIG. 2 shows an illustrative electronic control unit (ECU) software network stack;

FIG. 3A shows an illustrative physical network topology;

FIG. 3B shows a second illustrative physical network topology;

FIG. 3C shows an illustrative abstracted software network topology;

FIG. 4 shows an illustrative process for message handling using an illustrative 29-bit protocol.

### DETAILED DESCRIPTION

As required, detailed embodiments are disclosed herein; however, it is to be understood that the disclosed embodiments are merely illustrative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

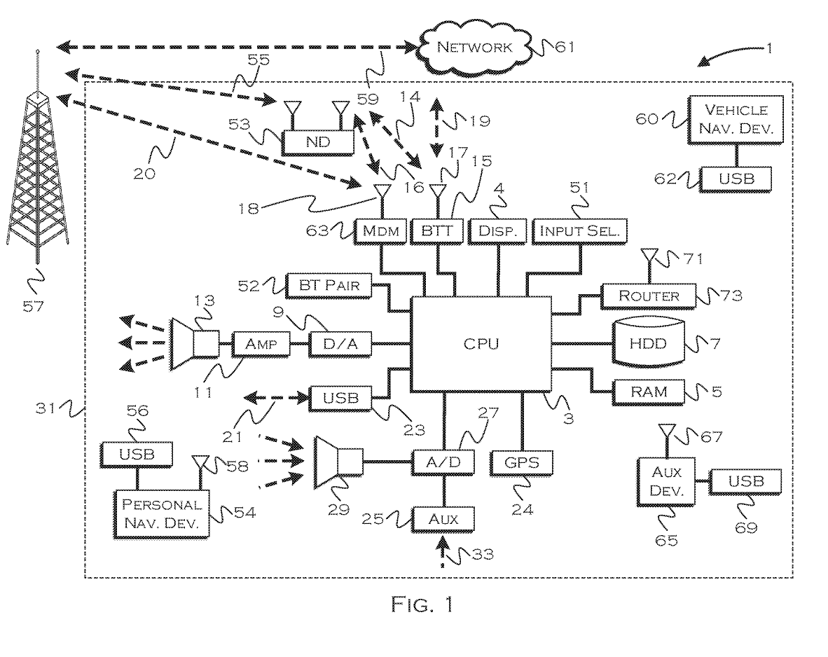

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a Wi-Fi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. If the user has a data-plan associated with the nomadic device, it is possible that the data-plan allows for broad-band transmission and the system could use wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., Wi-Fi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a Wi-Fi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

The illustrative embodiments provide an approach to solving physical layer bandwidth limitations while meeting use-case requirements that may be encountered by OEMs seeking to fully utilize the CAN network for enhanced vehicle telematics functionality. Some of the considerations addressed include, but are not limited to, security, payload, source-receiver, application identification, prioritization and dynamic changing of bandwidth utilization.

In present CAN communication in vehicles, a gateway module may facilitate communication between remote sources and ECUs, and between the ECUs themselves. Each ECU's address is prerecorded in a database, and the gateway module includes a persistent definition of these addresses, as well as a routing schema that fixedly defines which messages are routed to which ECU addresses and/or subnets. This schema may be fixed for a product line, and thus any message that would be desired to interact with a particular ECU across multiple product lines may need to be individually configured for each product line to accommodate the routing schema. By utilizing the illustrative embodiments, the addressing of ECUs (the physical address of the ECU) can be abstracted such that a message can be designated for the particular ECU, and the 29-bit protocol will help ensure the message arrives at the appropriate ECU on each product line, without having to reference the specific routing schema saved with respect to a gateway module on each product line.

The illustrative embodiments provide security formats, payload size and connectivity operations that allow for vehicle electronic control units (ECU)s to exist on the broader Internet Of Things ecosystem as independent entities routed through a centralized vehicle connectivity gateway. The proposed protocol (an on-vehicle telematics protocol (OVTP)) may be defined in a way that allows it to be accessible across multiple physical layers, and agnostic to Ethernet, CAN, local interconnect network (LIN), etc.

While the illustrative embodiments are described with respect to an on-vehicle telematics protocol, non-telematics related modules can also use the 29-bit protocol described to send and receive information. In the examples, the OVTP may be used to facilitate, for example, over-the-air (OTA) updates, but more generally modules of varied types can use the described protocol can be used to improve communication over the existing physical layers, which may share no relationship to telematics. For example, an OEM may elect to use the 29-bit protocol as a key distribution protocol for setting up secure CAN communications.

In one implementation, the OVTP is partitioned via two identification methodologies for CAN node identification. Specifically, OVTP communication will happen via a 29-bit identifier, while normal CAN communication will happen via standard 11-bit identifiers (11-bit identifiers being commonly used in vehicle architecture). This allows for a star network topology to be condensed into a singular network once abstracted to the OVTP layer. Routing will happen based on Net ID and whether the ID is 29-bit or 11-bit. Additionally, this allows for an ECU to recognize an OVTP request much lower in its network stack and ignore the message if the ECU does not support OVTP. This provides for more efficient message handling.

The OVTP on 29-bit also facilitates the use of the stack in parallel to a normal diagnostic request, thus allowing for the ECU to maintain connectivity even when in diagnostic mode in the vehicle. With only 11-bit protocols, for example, a vehicle in diagnostic mode (or having an insurance tracking or other device plugged into an onboard diagnostics (OBD) port can actually block communication with modules for purpose of updating those modules. With the OVTP on 29-bit protocol, ECU connectivity persists even when a customer or technician attaches a diagnostic device to the vehicle.

Also, by using 29-bit identifiers, the OVTP system may utilize a defined address space that facilitates abstraction of the node location on the bus, thus a node may communicate to the master through a dedicated channel regardless of where it sits in the vehicle and regardless of what physical layers are between the node and the destination. Thus, a sender does not need to know or identify the physical location of the node and the subnet on which the node resides for a particular product line before sending a message intended for that node (the request or message from the sender is agnostic with regards to the address). Through use of the protocol, the gateway provided to a vehicle dynamically learns on which network the ECU is located.

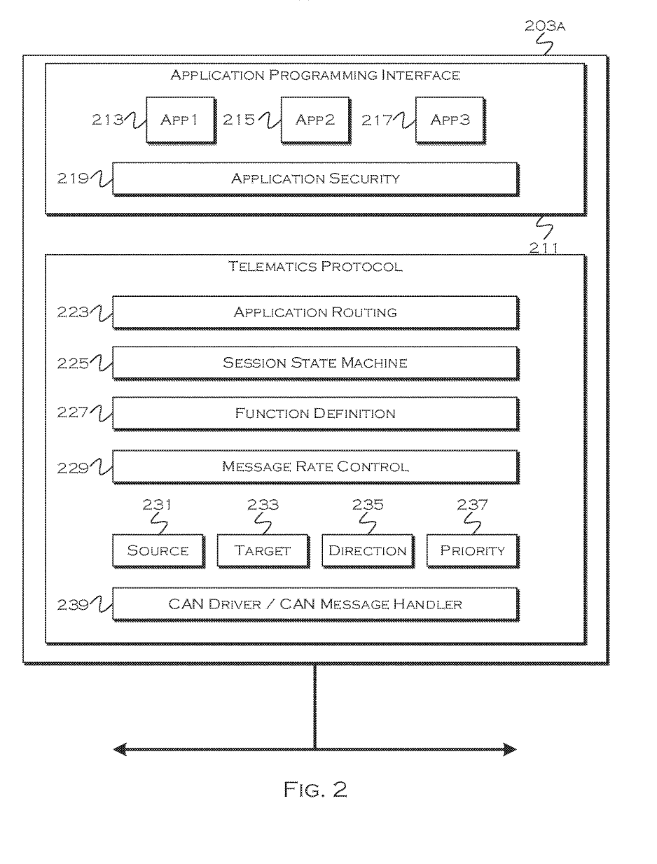

FIG. 2 shows an illustrative electronic control unit (ECU) software network stack 203a. Various applications 213, 215, 217 execute on the ECU to provide the functionality ascribable to that ECU. The interaction of the ECU specific applications with other ECUs and remote entities, over the CAN, is facilitated by a common application programming interface 211. The API layer also includes application security.

Applications that utilize the OVTP may require header information that can properly route the information provided in the payload. Illustrative parameters used for that identification are contained as part of the message header. This allows for OVTP to support numerous furture physical layer implementations. Illustrative header information used by one example of OVTP is described below.

| Header Parameter | Description | Bit Allocation |
|---|---|---|
| Priority | Used to define the priority of | 3 bits |
| | the message relative to the | |
| | vehicle control signals | |
| <Reserved> | Reserved bits for future use | 3 bits |
| Application | Used to define the application | 3 bits |
| | that is sending or receiving | |
| | information | |
| Target | Used to define the module that | 10 bits |
| | will be receiving the message | |
| | transmitted | |
| Source | Used to define the module that | 10 bits |
| | will be sending the message | |
| | transmitted | |

In this example, a Priority Parameter defines the priority of the messages relative to the diagnostic and control messages on the vehicle. An individual server may not care what the contents of these three bits are. These may be used for the client to be able to dynamically assign networking priority. An example of this parameter with an illustrative value is shown below.

| Priority | Value | SDLC Routing |
|---|---|---|
| Default Value | 0b110 | Don't Care |

A <Reserved> Section defines a reserved section of the 29-bit header for future development. In one illustrative implementation, as long as this section is reserved, the OVTP handler shall reject any Net ID's that don't have a certain value specified in this location. An example of this parameter with an illustrative value is shown below.

| Priority | Value | SDLC Routing |
|---|---|---|
| Default Value | 0b111 | Don't Care |

An Application Parameter defines which application is using OVTP to transmit or receive module application information. Non-limiting examples of this parameter with illustrative values are shown below. Inclusion of the application parameter bits allow multiple transactions to occur to the same ECU (e.g., a segmented OTA request being transmitted in parallel to a segmented command and control request). So a diagnostic read request can co-exist on the physical layer with an update request, which wouldn't be possible using existing vehicle architecture and only an 11-bit protocol.

| Application | Value | SDLC Routing |
|---|---|---|
| OTA | 0b001 | Don't Care |
| PARSED Request Response | 0b010 | Don't Care |
| PARSED Push | 0b011 | Don't Care |
| Command and Control | 0b100 | Don't Care |
| Wrapped Diagnostics | 0b101 | Don't Care |

In the above table, the various applications, while illustrative in nature, may correspond to the following:

OTA Application—each ECU may interpret messages being routed under this application as Over the Air Software Update messages, and route the messages to an OTA-corresponding application provided to the ECU, for handling.

PARSED Request Response Application—each ECU may interpret messages being routed under this application as Processing and Reporting System for Efficient Data upload messages, and route the messages to a corresponding application for handling.

PARSED Push Application—The PARSED Push Application may contain the functioning transmission of data based on an internal ECU event. The Push functionality may only be active when the PARSED application has been properly configured by the Request Response component of PARSED.

A Target parameter defines a target module for the OVTP message. For messages originating at the Client, the target may be defined as the ECU that is receiving the Client information. Typically, for requests the Target is the Server, and for responses the Target is the Client. Individual module definitions are based upon ECU addresses stored in a database. Inclusion of this parameter allows for a hardware routing numeric value to be applied to software abstraction layers in a controlled manner. This allows for routing of data through various software layers without having to open up a payload. For example, the first several layers of the software stack can do this routing, and the next layers of the stack know to look at the first byte to determine if the software is valid. This allows for each abstraction layer of the hardware to leverage the hardware characteristics of design to maximize efficiency.

By using the first 10 bits for the target, in one example, a vehicle computer can configure a module at the physical layer to filter those 10 bits to look for only information coming from a specific ECU (bottom two layers of software), and everything above the physical layer can ignore the message.

A Source parameter defines an originating module for the OVTP message. For messages originating at the Client, the Source may be defined as the Client that is sending the information to the Server. Typically, for requests the Source is the Client, and for responses the Source is the Server. Again, individual module definitions are based upon ECU addresses stored in the database.

Source identification allows for multiple sources talking to multiple targets all independently without a conflict of information flow on the network. The addressing componentry, instead of being hardcoded, is now designed as logical constructs are in the software that facilitates the use of the 10 source bits and the overall 20 source/target bits. This allows for an application that provides mesh-based networking of module messages across the entire network without conflict. This also leverages the physical layers of the CAN protocol design relative to other networks, which can allow for multiple senders and receivers on the same physical wire.

For example, a system could have two modules on the vehicle that both have internet connection—such as an infotainment module and a telematics module. These may represent different nodes, having different source addresses, which both talk on CAN. Under the illustrative embodiments, those two modules can control both the same downstream or separate modules at the same time, there are no conflicts of message transmission on the physical wire of the network. This also allows for addition of connected modules without requiring architecture redesign.

The table below shows illustrative 29-bit NetIDs for illustrative messages of various application types from various senders to various receivers, conforming to the illustrative protocol as described above.

| Sender | Receiver | Application | NetID |
|---|---|---|---|
| ECU 1 (0x11) | ECU2 | App1 | 0x1BA08811 |
| | (0x22) | Req/Resp | |
| ECU 2 (0x22) | ECU1 | App1 | 0x1BA04422 |
| | (0x11) | Req/Resp | |
| ECU 2 (0x22) | ECU1 | App 1 Push | 0x1BB08811 |
| | (0x11) | | |
| ECU 1 (0x11) | ECU3 | App 2 | 0x1B90CC11 |
| | (0x33) | | |
| ECU 3 (0x33) | ECU1 | App 2 | 0x1B904433 |
| | (0x11) | | |
| ECU 4 (0x44) | ECU2 | App | 0x1BA04044 |
| | (0x11) | 1Req/Resp | |
| ECU 1 (0x11) | ECU4 | App | 0x1BA11011 |
| | (0x44) | 1Req/Resp | |
| Funct (0x3FF) | ECU3 | App 2 | 0x1B9CC3FF |
| | (0x33) | | |

A telematics protocol is also included in the ECU network stack. This protocol defines request-addressing for a request, allowing the ECU to interpret the request in accordance with specific parameters stored at specific bits within the request. The protocol defined on the ECU stack will provide for application routing 223. This allows the ECU to route a request to a particular ECU-specific application 213, 215, 217 to which the request is directed (or which will handle the request). A request includes a definition of the target application 233, which may be 3 bits of the request in a 29-bit protocol request.

The ECU network stack also includes handling for creating and maintaining a session statemachine 225 The Session statemachine may be used for the following purposes, for example:
Reject unsecure or improperly encrypted requests
Allow the ECU to release resources that may be in use for PARSED or OTA to other applications because a session is not active
Suppress transmission of data so that an OEM can remotely control the bandwidth utilization of the vehicle network.
Provide a handshake so that the Server knows that the Client is awake and ready to receive data.

The protocol includes a set of function definitions 227, which define functions that are utilized by various schema taking advantage of the 29-bit protocol. For example, without limitation, over the air updates (OTA) have a defined set of available functions, and these function definition bits can reference a function associated with a message. Finally, the protocol includes a message rate control portion 229, which controls the fastest that individual CAN frames for a given OVTP message, which often consist of multiple CAN frames, can be sent. This allows for dynamic and predictable control of the maximum bandwidth that will be utilized.

A given request to/from the ECU that will be handled by the ECU stack will include a source identification 231 (10 bits of the 29-bit OVTP protocol), a target module identification 233 (10 bits of the 29-bit OVTP protocol), and a priority identification 237.

The protocol also includes functionality 239 for CAN message handling, which allows the ECU to Send Messages, Receive Messages, and Push Messages to the CAN.

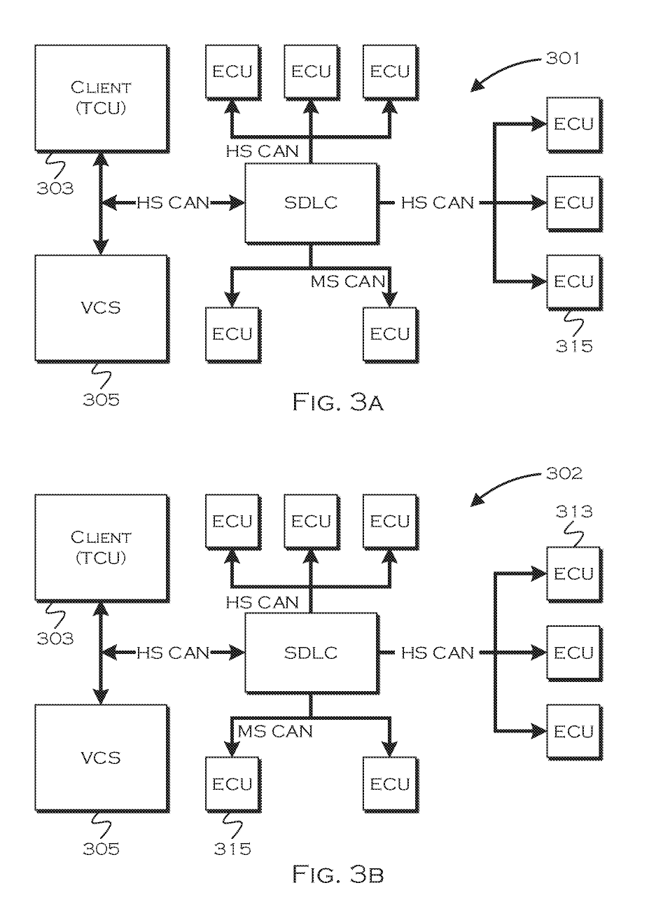

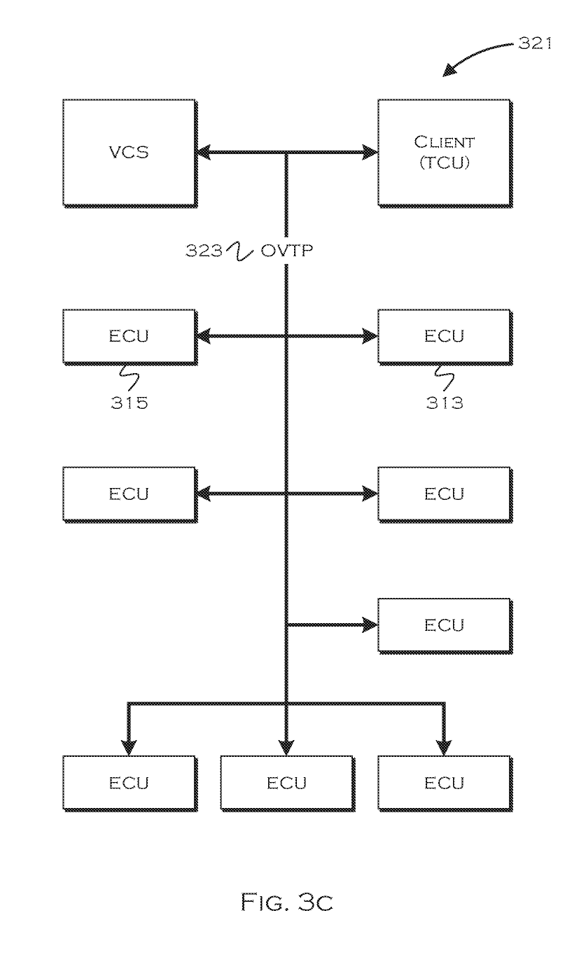

FIG. 3A shows an illustrative physical network 301 topology. This illustrative physical network includes a client (in this example the TCU) 303 and a vehicle computing system 305 (such as an infotainment system like FORD SYNC). A high-speed (HS) CAN connects the TCU and VCS to a synchronous data link control module (SDLC) 309. The SDLC handles communication between the TCU (which can include remote requests received via the TCU), VCS (which can include occupant requests received via the VCS), and the various ECUs 313, 315. Some of the ECUs communicate with the SDLC via a high speed (HS) CAN and some communicate via a medium speed (MS) CAN 311.

FIG. 3B shows a second illustrative physical network topology 302. This represents a physical network similar to that of FIG. 3A, but on a different product line. As seen in FIG. 3B, the various ECUs 313, 315 in this product line, corresponding to the same ECU types in that of FIG. 3A, reside on different subnets in this product line.

FIG. 3C shows an illustrative abstracted software network topology 321.

In this abstracted version of the physical network topology, the OVTP 323 facilitates communication between the various ECUs 313, 315 regardless of where the ECUs actually reside in the physical network. As such, this abstraction can be representative of both physical networks shown in FIGS. 3A and 3B, and demonstrates how the physical address of the ECU does not necessarily need to be known for message handling once the network is abstracted to this level.

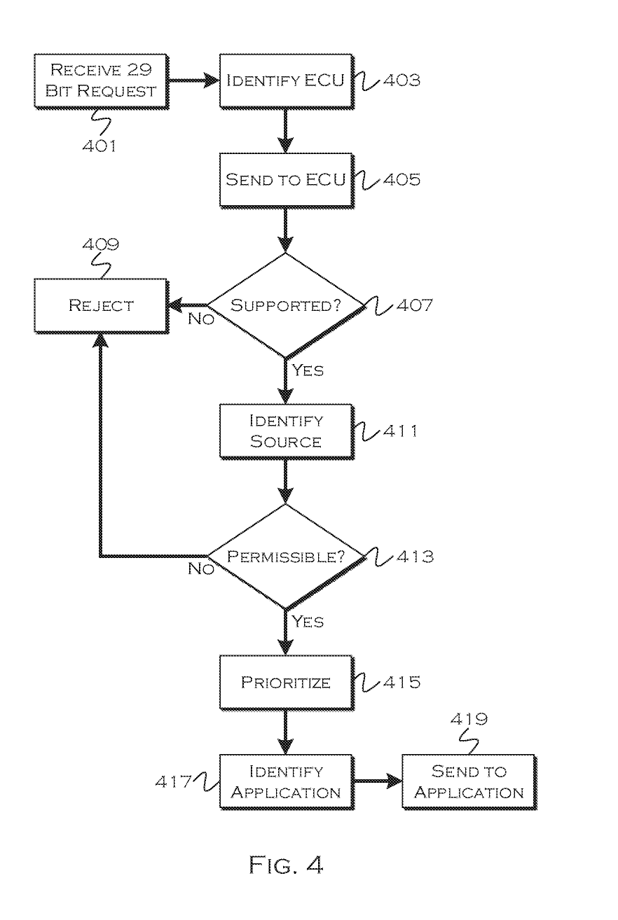

FIG. 4 shows an illustrative process for message handling using an illustrative 29-bit protocol. In this illustrative example, a handling process receives a 29-bit request 501, such as those described in the illustrative embodiments. Based on a target identifier included in the message, for example, the process determines which ECU should receive the request 503. In this example, the ECU addresses identified in the request have been abstracted, so the request identifies the abstracted address, not the address of the ECU. This accommodates for ECUs located on different networks in different product lines (i.e., a single formatted request can be passed to multiple product lines without having to know the addresses of the intended recipient-ECUs).

The message is routed to a relevant ECU 505, based on the target identifier. The ECU can determine if it can handle a 29-bit request 507. Some ECUs which are intended recipients of 29-bit requests may not be configured to handle 29-bit requests, so these ECUs can reject 29-bit requests 509 low in the stack, if such requests are not supported. If the requests are supported, the ECU can determine the source 511, which is also identified in the 29-bit request.

Since only certain verified sources may be permitted to send requests to an ECU, for example, the ECU may reject requests from sources that are not identified as permissible sources for sending a request to the ECU.

Also, in this example, the 29-bits include a priority identifier, which allows the receiving ECU to prioritize the incoming request 515. The request also includes an identifier which identifies an application, executing as part of the ECU, which will handle the payload associated with the request. The ECU can identify this application based on the appropriate bits in the request 517, and route the payload associated with the request to the appropriate application 519. The application executing on the ECU can then handle the request appropriately.

While illustrative embodiments are described above, it is not intended that these embodiments describe all possible forms. Rather, the words used in the specification are words of description rather than limitation, and it is understood that various changes may be made without departing from the spirit and scope of the invention. Additionally, the features of various implementing embodiments may be combined as would be understood by a skilled artisan to form variations that achieve the same ends as discussed with respect to the illustrative examples.

What is claimed is:

1. A system comprising:
a processor configured to:
receive a 29-bit request transmitted over a vehicle controller area network (CAN) bus;
identify a vehicle electronic control unit (ECU) as a target recipient based on a target identifier included with the request;
identify a source which sent the request based on a source identifier included with the request;
verify the identified source as permitted to send the request to the ECU; and
responsive to the verification, route the request to an ECU application, executing on the ECU, identified by an application identifier included with the request.

2. The system of claim 1, wherein the target identifier is a 10-bit identifier.

3. The system of claim 1, wherein the target identifier identifies a software-abstracted address for the ECU.

4. The system of claim 1, wherein the source identifier is a 10-bit identifier.

5. The system of claim 1, wherein the application identifier is a 3-bit identifier.

6. The system of claim 1, wherein the processor is configured to:
determine if the ECU is capable of handling 29-bit requests; and
reject the request if the ECU is incapable of handling 29-bit requests.

7. The system of claim 1, wherein the processor is configured to:
identify a request priority based on a priority designation included with the request; and
prioritize the request for processing in accordance with the request priority.

8. The system of claim 7, wherein the priority designation is a 3-bit identifier.

9. The system of claim 1, wherein the request is agnostic with regards to a physical address of the ECU.

10. A computer-implemented method comprising:
responsive to receipt of a 29-bit message, including a 10-bit target identifier identifying a target electronic control unit (ECU) and 10-bit source identifier identifying a message source, routing, the message to the identified target ECU via a synchronous data link control module, following verification by the ECU of both the identified source as being permitted to exchange messages with the ECU and 29-bit request handling capability.

11. The method of claim 10, wherein the 10-bit target identifier identifies an abstracted ECU address.

12. The method of claim 10, further comprising:
extracting an application identifier from the message, via the ECU, identifying an ECU application designated to handle the message; and
routing a message payload to the ECU application identifier by the application identifier.

13. The method of claim 10, wherein the application identifier is a 3-bit identifier.

14. A non-transitory computer-readable storage medium storing instructions that, when executed by a processor, cause the processor to perform a method comprising:
identifying a vehicle electronic control unit (ECU) as a target recipient based on a target identifier included with a 29-bit request from a vehicle controller area network (CAN) bus;
verifying a source identified in the 29-bit request as permitted to send the request to the ECU; and
route the request to an ECU application, executing on the ECU, responsive to the verification, the application identified by an application identifier included with the request.

15. The storage medium of claim 14, wherein the target identifier is a 10-bit identifier.

16. The storage medium of claim 15, wherein the target identifier identifies a software-abstracted address for the ECU.

17. The storage medium of claim 14, wherein the verifying is performed by the ECU.

18. The storage medium of claim 14 wherein the application is identified by a 3-bit identifier.

19. The storage medium of claim 14, wherein the method further includes rejecting the request responsive to a determination by the ECU that the ECU is incapable of handling 29-bit requests.

20. The storage medium of claim 14, wherein the request is agnostic with regards to a physical address of the ECU.
